(19) United States
(12) Patent Application Publication
(10) Pub. No.: US 2021/0398332 A1
(43) Pub. Date: Dec. 23, 2021

(54) RICH MARKER FOR MAPPING APPLICATIONS

(71) Applicant: Sensormatic Electronics, LLC, Boca Raton, FL (US)

(72) Inventor: Juan Miguel CAMARASA, Glantane Cork (IE)

(21) Appl. No.: 16/904,307

(22) Filed: Jun. 17, 2020

(51) Int. Cl. G06T 11/60; G09B 29/00

(52) U.S. Cl. CPC G06T 11/60; G09B 29/006

(57) ABSTRACT

A computer displays a marker indicating a point-of-interest in a map display. The marker is characterized by a pole and a polar axis. The marker includes a band characterized by a radial width between an inner radial edge and an outer radial edge in relation to the pole, and an angular extent in relation to the polar axis. At least one of the radial width and the angular extent is a function of a feature of the point-of-interest.

### TECHNICAL FIELD

The technology disclosed herein is related to the structure and function of graphic user interface (GUI) elements. Particular examples relate to particular structures and functions of marker GUI elements in computer-displayed maps.

### BACKGROUND

A map symbol is a GUI element that may be used to visually represent a real-world phenomenon or a characteristic thereof on a computer-displayed map. In particular, a symbol known as a “marker” may be used to represent location and one or more characteristics of a point-of-interest on the displayed map.

### SUMMARY

The technology described herein includes computer implemented methods, computer program products, and systems to describe one or more features of a point-of-interest in a map display. In examples of the technology, a computer displays a marker indicating a point-of-interest in a map display. The marker is characterized by a pole and a polar axis. The marker includes a band characterized by a radial width between an inner radial edge and an outer radial edge in relation to the pole, and an angular extent in relation to the polar axis. At least one of the radial width and the angular extent is a function of a feature of the point-of-interest.

In some examples, marker includes a second band characterized by a second radial width in relation to the pole and an second angular extent in relation to the polar axis. In such examples, at least one of the second radial width and the second angular extent is a function of a feature of the point-of-interest. In some examples, the feature is a quantitative feature. In some examples, the first inner edge is the pole. In some examples, the inner edge is at a positive radial distance from the pole.

In some examples, the computer displays a second marker indicating a second point-of-interest in the map display. In such examples, the second marker is characterized by a second pole and a second polar axis. The second marker includes a second-marker band characterized by a second-marker band radial width between a second-marker band inner radial edge and a second-marker band outer radial edge in relation to the second pole, and a second-marker band angular extent in relation to the second polar axis. In such examples, at least one of the second-marker band radial width and the second-marker band angular extent is a function of a feature of the second point-of-interest. In some examples, the computer displays a legend indicating the correspondence between features and characteristics.

These and other aspects, objects, features, and advantages of the technology described herein will become apparent to those having ordinary skill in the art upon consideration of the following detailed description of illustrated examples.

### BRIEF DESCRIPTION OF THE DRAWINGS

FIG. 1 is a block diagram depicting an operating environment to describe one or more features of a point-of-interest in a map display, in accordance with certain examples of the technology disclosed herein.

FIG. 2 is a diagram illustrating polar coordinates.

FIG. 3 is a block diagram illustrating methods to describe one or more features of a point-of-interest in a map display, in accordance with certain examples of the technology disclosed herein.

FIG. 4 is a diagram illustrating a marker, in accordance with certain examples of the technology disclosed herein.

FIG. 5 is a diagram illustrating an example use of markers to describe one or more features of two points-of-interest in a map display, in accordance with certain examples of the technology disclosed herein.

FIG. 6 is a block diagram depicting a computing machine and a module, in accordance with certain examples of the technology disclosed herein.

### DETAILED DESCRIPTION OF EXAMPLES

In computer-implemented map displays, markers such as the teardrop shaped icon used by Google LLC may be used to indicate a location and other characteristics of a point-of-interest in a computer-displayed map. However, space often is at a premium in map displays and information rich descriptions of locations are difficult to present in a small space in map displays. Typically, markers convey only location and category—the latter often through iconography. In some cases, approaches such as pop-up windows, activated by a click or hover-over event for example, are used to convey additional information. However, pop-up windows contribute to clutter in the map display. By using and relying on the methods, systems, and computer program products described herein, the technology disclosed herein can convey information in a more compact form than typical approaches. As such, the technology may be employed to reduce clutter in GUIs and improve computer-based information transfer.

Turning now to the drawings, in which like numerals represent like (but not necessarily identical) elements throughout the figures, examples of the present technology are described in detail.

### Example System Architectures

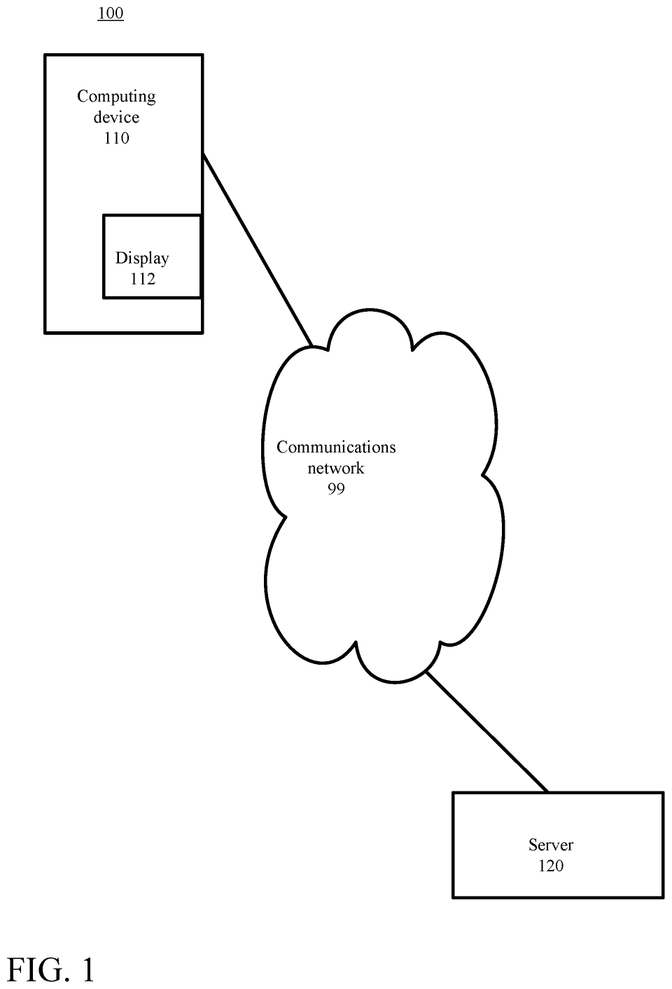

FIG. 1 is a block diagram depicting an example operating environment 100 in accordance with examples of the technology disclosed herein. While each server, system, and device shown in the operating environment is represented by one instance of the server, system, or device, multiple instances of each can be used. Further, while certain aspects of operation of the present technology are presented in examples related to FIG. 1 to facilitate enablement of the claimed invention, additional features of the present technology, also facilitating enablement of the claimed invention, are disclosed elsewhere herein.

As depicted in FIG. 1, the example operating environment 100 includes computing device 110 and server 120. Each of computing device 110 and server 120 may be configured to communicate with one another via communications network 99. In some examples, a user associated with a device may install an application and/or make a feature selection to obtain the benefits of the technology described herein.

Communications network 99 includes one or more wired or wireless telecommunications means by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system, that facilitates the RF communication of signals, data, and/or messages. Throughout the discussion of examples, it should be understood that the terms “data” and “information” are used interchangeably herein to refer to text, images, audio, video, or any other form of information that can exist in a computer-based environment.

Each of computing device 110 and server 120 can include a communication module (not separately shown) capable of transmitting and receiving data over the network 99. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device.

In examples described herein, computing device 110 and server 120 are computing resources that are individually or cooperatively operative to practice examples of the technology disclosed herein. In some examples, the computing device 110 is a consumer computing device such as a smart phone, a laptop computer, or a desktop computer. In some examples, computing device 120 is a server providing data for display on display 112 of computing device 110.

The connections illustrated are examples, and other means of establishing a communications link between the computers and devices can be used. Moreover, those having ordinary skill in the art having the benefit of the present disclosure will appreciate that the computing devices illustrated in FIG. 1 may have any of several other suitable computer system configurations. For example, computing device 110 may be embodied as a system and may not include all the components described above.

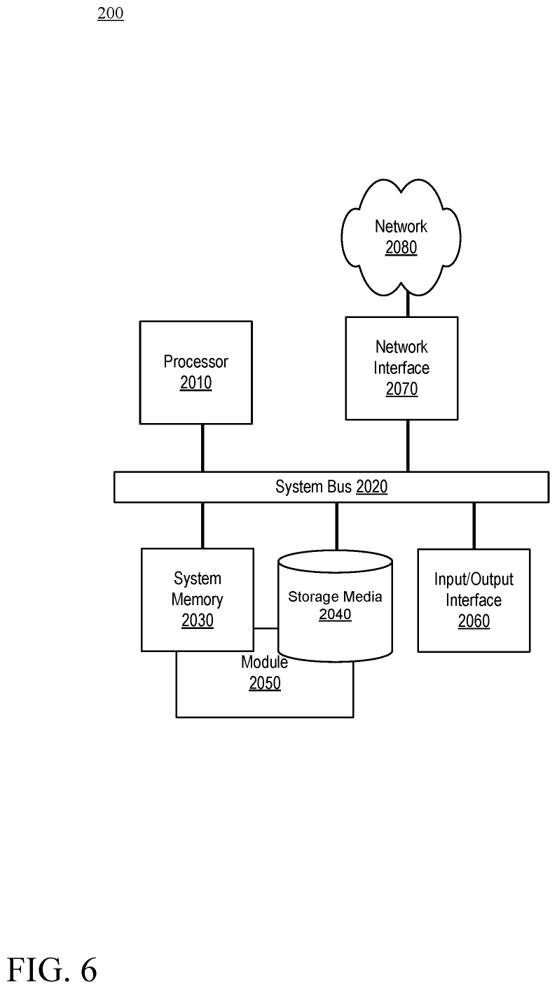

In examples, the computing devices, and any other computing machines associated with the technology presented herein, may be any type of computing machine such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may be any of the modules discussed in more detail with respect to FIG. 6. The computing devices discussed herein may communicate with one another as well as other computer devices or communication systems over one or more networks, such as network 99. The network 99 may include any type of data or communications network, including any of the network technology discussed with respect to FIG. 6.

### Example Processes

The examples illustrated in the figures are described hereinafter with respect to the components of the example operating environment 100. The examples also can be performed with other systems and in other environments. The operations described with respect to any of the figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

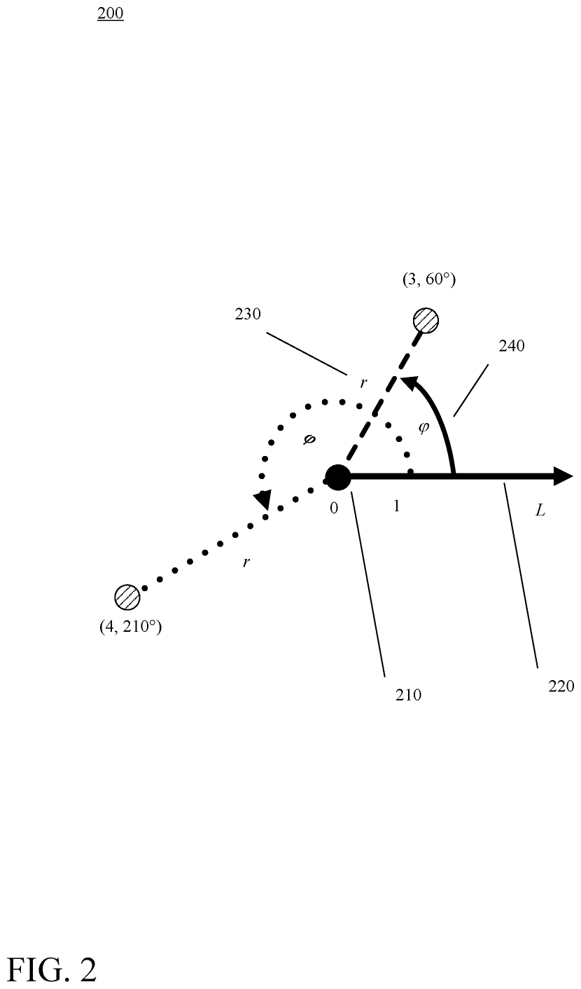

Referring to FIG. 2, a polar coordinate system 200 used in describing examples of the technology disclosed herein is shown. The polar coordinate system 200 is a two-dimensional coordinate system in which each point on a plane is determined by a distance from a reference point and an angle from a reference direction. The reference point (analogous to the origin of a Cartesian coordinate system) is called the “pole” 210 (also labeled as “0” in FIG. 2), and the ray from the pole 210 in the reference direction is the “polar axis” 220 (also labeled as “L” in FIG. 2). The distance from the pole 210 is called the radial coordinate “r” 230, radial distance, or simply radius; and the angle “φ” 240 is called the angular coordinate, polar angle, or azimuth.

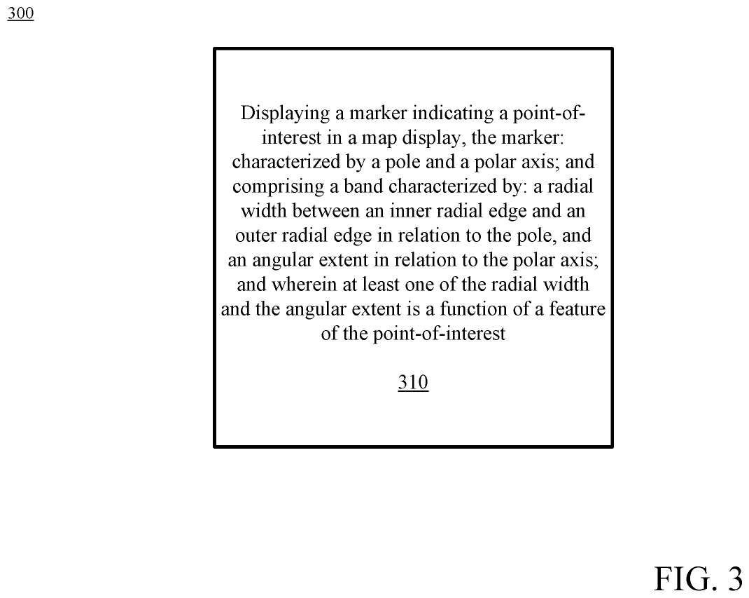

Referring to FIG. 3, and continuing to refer to prior figures for context, methods 300 to describe one or more features of a point-of-interest in a map display are illustrated in accordance with certain examples. In such methods 300, a computing device displays a marker indicating a point-of-interest on a map display—Block 310. The marker is characterized by a pole and a polar axis. The marker includes a band characterized by 1) a radial width between an inner radial edge and an outer radial edge in relation to the pole, and 2) an angular extent in relation to the polar axis. At least one of the radial width and the angular extent is a function of a feature of the point-of-interest.

As described above, the computing device can be computing device 110 displaying the marker on a native display of the computing device 110. The computing device can also be server 120 providing data to computing device 110 for display on the native display of computing device 110.

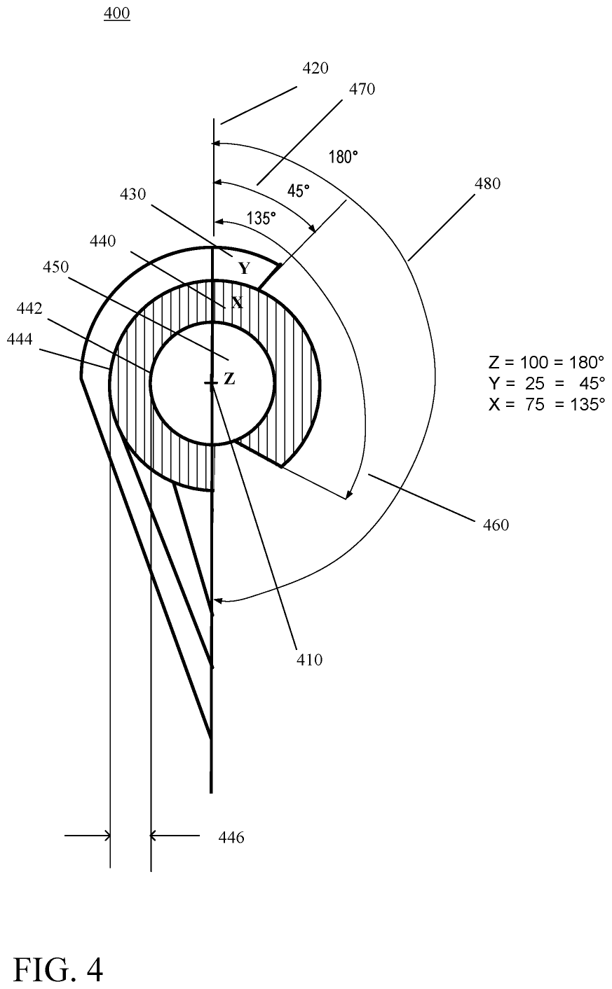

In FIG. 4, an example marker 400 to describe one or more features of a point-of-interest in a map display is shown, in accordance with certain examples of the technology disclosed herein. The marker 400 is characterized by a pole 410 and a polar axis 420 through the pole 410. The marker 400 includes three bands—an X band 440, a Y band 430, and a Z band 450. Using the X band 440 as an example band, each band has an inner radial edge (e.g., inner radial edge 442) and an outer radial edge (e.g., outer radial edge 444) in relation to the pole 410.

The uniform normal distance between the inner radial edge and the outer radial edge is the radial width of the band, e.g., radial width 446. In the example, Each band has an angular extent (e.g., angular extent 460) in relation to the polar axis 420. In FIG. 4, the angular extent (e.g., angular extent 460) of a given band (e.g., Xband 440) from the top portion of the polar axis 420 toward the bottom portion of the polar axis 420 represents a value from 0-100 (e.g., for the Xband 440 the value is 75%, or ¾ of the way, or 135° from the top portion of the polar axis 420 toward the bottom portion of the polar axis 420). In other examples, any line through the pole can serve as the polar axis, and angular extent can be measured over a range that includes both positive and negative angular extents with reference to the pole. Angular extent can be measured in any convenient units, e.g., degrees or radians.

For the Y band 430 the angular extent 470 is 25%, or ¼ of the way, or 45° from the top portion of the polar axis 420 toward the bottom portion of the polar axis 420. For the Z band 450 the angular extent is 100%, or all the way, or 180° from the top portion of the polar axis 420 toward the bottom portion of the polar axis 420. In the case of FIG. 4, the angular extent is a function of a feature of a point-of-interest that the marker 400 is used to indicate. Further, FIG. 4 includes both second band, Y band 430, and a third band, Z band 450—each with an angular extent as a function of a feature of the intended point-of-interest, for example commute time by solo drivers for Xband 440, commute time by carpoolers for Y band 430, and commute time for public transit users for Z band 450. In that example, it can be seen that each of X band 440, Y band 430, and Z band 450 are expressed as a function of percentage of the Z band 450.

For both the X band 440 and the Y band 430, the inner edge is at a positive radial distance from the pole, and the band width tapers in a teardrop fashion toward the bottom of the polar axis 420. For the Z band 450, the inner edge is the pole 410 itself.

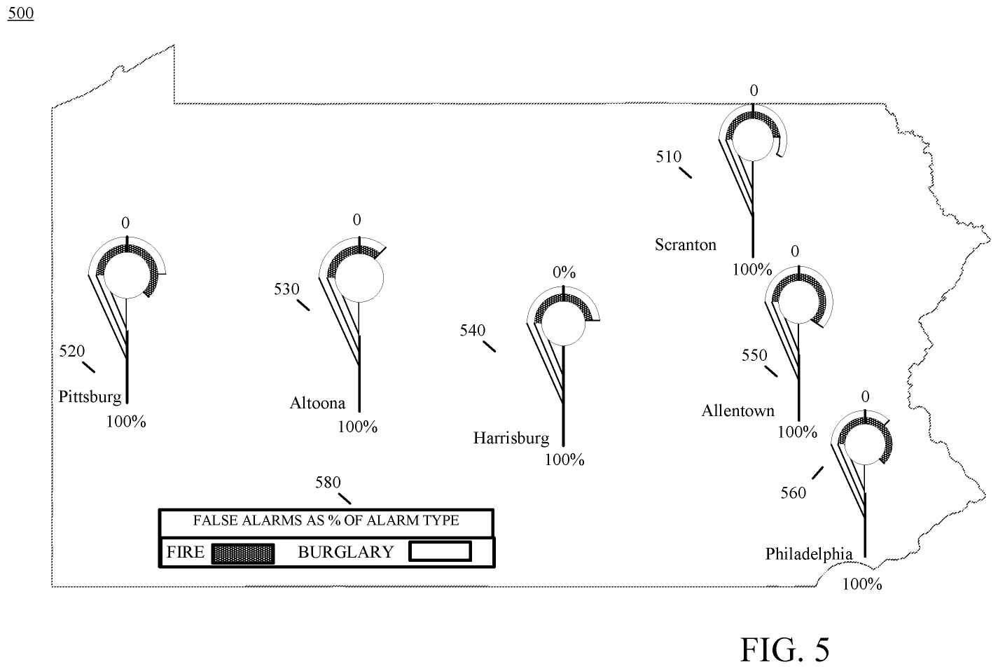

Referring to FIG. 5, and continuing to refer to prior figures for context, a computer map display 500 illustrating an example use of markers 510-560 to describe one or more features of points-of-interest in the computer map display 500 is shown, in accordance with certain examples of the technology disclosed herein. The map display is of Pennsylvania, showing several of the largest cities. Each marker 510-560 is a two-band marker using X band 440 and Y band 430 as described in conjunction with FIG. 4. The center of each marker 510-560 is solid and does not correspond to Z band 450 from FIG. 4. Each X band represents the average monthly percentage of fire security alarms that are false alarms at the point-of-interest. Each Y band represents the average monthly percentage of burglary security alarms that are false alarms at the point-of-interest. TABLE 1 summarizes the data in table form. FIG. 5 presents the data in a map display. FIG. 5 also presents a legend 580 for distinguishing the meaning of each band in each marker 510-560.

TABLE 1

| | False Fire Alarms as a % of | False Burglary Alarms as a % |
|---|---|---|
| CITY | Fire Alarms | of Burglary Alarms |
| Allentown | 75 | 75 |
| Altoona | 25 | 25 |
| Harrisburg | 50 | 50 |
| Philadelphia | 25 | 75 |
| Pittsburg | 75 | 50 |
| Scranton | 50 | 75 |

### Other Examples

FIG. 6 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain examples, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

The present technology may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the present technology in computer programming, and the examples should not be construed as limited to any one set of computer program instructions. Further, a skilled programmer would be able to write such a computer program to implement the present technology as described herein based on the appended flow charts and associated description in the application text. Therefore, disclosure of a particular set of program code instructions is not considered necessary for an adequate understanding of how to make and use the technology described herein. Further, those skilled in the art will appreciate that one or more aspects of the technology described herein may be performed by hardware, software, or a combination thereof, as may be embodied in one or more computing systems. Moreover, any reference to an act being performed by a computer should not be construed as being performed by a single computer as more than one computer may perform the act.

The technology described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the examples presented previously are illustrative, and, in alternative examples, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation to encompass such alternate examples. For example, an input such as

Although specific examples have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of technology described herein defined in the following claims, the scope of which is to be accorded the broadest interpretation so as to encompass such modifications and equivalent structures.

What is claimed is:

1. A computer-implemented method to describe one or more features of a point-of-interest in a map display, comprising:
displaying a marker indicating a point-of-interest in a map display, the marker:
characterized by a pole and a polar axis; and
comprising a band characterized by:
a radial width between an inner radial edge and an outer radial edge in relation to the pole, and
an angular extent in relation to the polar axis; and
wherein at least one of the radial width and the angular extent is a function of a feature of the point-of-interest.

2. The method of claim 1, the marker comprises a second band characterized by:
a second radial width in relation to the pole, and
an second angular extent in relation to the polar axis; and
wherein at least one of the second radial width and the second angular extent is a function of a feature of the point-of-interest.

3. The method of claim 1, wherein the feature is a quantitative feature.

4. The method of claim 1, wherein the inner radial edge is the pole.

5. The method of claim 1, wherein the inner radial edge is at a positive radial distance from the pole.

6. The method of claim 1, further comprising:
displaying a second marker indicating a second point-of-interest in the map display, the second marker:
characterized by a second pole and a second polar axis; and
comprising a second-marker band characterized by:
a second-marker band radial width between a second-marker band inner radial edge and a second-marker band outer radial edge in relation to the second pole, and
a second-marker band angular extent in relation to the second polar axis; and
wherein at least one of the second-marker band radial width and the second-marker band angular extent is a function of a feature of the second point-of-interest.

7. The method of claim 1, further displaying a legend indicating a correspondence between features and characteristics.

8. A computer program product, comprising:
a non-transitory computer-readable storage device having computer-executable program instructions embodied thereon that when executed by a computer cause the computer to describe one or more features of a point-of-interest in a map display, the computer-executable program instructions comprising instructions to:
display a marker indicating a point-of-interest in a map display, the marker:
characterized by a pole and a polar axis; and
comprising a band characterized by:
a radial width between an inner radial edge and an outer radial edge in relation to the pole, and
an angular extent in relation to the polar axis; and
wherein at least one of the radial width and the angular extent is a function of a feature of the point-of-interest.

9. The computer program product of claim 8, the marker comprises a second band characterized by:
a second radial width in relation to the pole, and
an second angular extent in relation to the polar axis; and
wherein at least one of the second radial width and the second angular extent is a function of a feature of the point-of-interest.

10. The computer program product of claim 8, wherein the feature is a quantitative feature.

11. The computer program product of claim 8, wherein the inner radial edge is the pole.

12. The computer program product of claim 8, wherein the inner radial edge is at a positive radial distance from the pole.

13. The computer program product of claim 8, wherein the computer-executable program instructions further comprise instructions to:
display a second marker indicating a second point-of-interest in the map display, the second marker:
characterized by a second pole and a second polar axis; and
comprising a second-marker band characterized by:
a second-marker band radial width between a second-marker band inner radial edge and a second-marker band outer radial edge in relation to the second pole, and
a second-marker band angular extent in relation to the second polar axis; and
wherein at least one of the second-marker band radial width and the second-marker band angular extent is a function of a feature of the second point-of-interest.

14. The computer program product of claim 8, wherein the computer-executable program instructions further comprise instructions to further displaying a legend indicating a correspondence between features and characteristics.

15. A system to describe one or more features of a point-of-interest in a map display, comprising:
a storage device;
a processor communicatively coupled to the storage device, wherein the processor executes instructions that are stored in the storage device to cause the system to:
display a marker indicating a point-of-interest in a map display, the marker:
characterized by a pole and a polar axis; and
comprising a band characterized by:
a radial width between an inner radial edge and an outer radial edge in relation to the pole, and
an angular extent in relation to the polar axis; and
wherein at least one of the radial width and the angular extent is a function of a feature of the point-of-interest.

16. The system of claim 15, the marker comprises a second band characterized by:
a second radial width in relation to the pole, and
an second angular extent in relation to the polar axis; and
wherein at least one of the second radial width and the second angular extent is a function of a feature of the point-of-interest.

17. The system of claim 15, wherein the feature is a quantitative feature.

18. The system of claim 15, wherein the inner edge is the pole.

19. The system of claim 15, wherein the inner edge is at a positive radial distance from the pole.

20. The system of claim 15, wherein the instructions further comprise instructions to:
display a second marker indicating a second point-of-interest in the map display, the second marker:
characterized by a second pole and a second polar axis; and
comprising a second-marker band characterized by:
a second-marker band radial width between a second-marker band inner radial edge and a second-marker band outer radial edge in relation to the second pole, and
a second-marker band angular extent in relation to the second polar axis; and
wherein at least one of the second-marker band radial width and the second-marker band angular extent is a function of a feature of the second point-of-interest.
